(19) United States
(12) Patent Application Publication
(10) Pub. No.: US 2025/0333018 A1
(43) Pub. Date: Oct. 30, 2025

(54) VEHICLE PET BARRIER

(71) Applicant: DMJ Holdings, LLC, Carthage, MO (US)

(72) Inventors: Jerry D. Overton, Grove, OK (US); Donna L. Overton, Grove, OK (US); James M. Randall, Grove, OK (US)

(21) Appl. No.: 18/645,214

(22) Filed: Apr. 24, 2024

(51) Int. Cl. B60R 21/06; B60R 21/02

(52) U.S. Cl. CPC B60R 21/06; B60R 2021/028

(57) ABSTRACT

A vehicle pet barrier blocks part of an opening, such as a doorway, of a vehicle without physically restraining the pet. This allows the pet to feel and sense the edge of the opening to avoid falling or slipping out as the vehicle is moving without physically restraining the pet. Once a pet becomes accustomed to the vehicle pet barrier, the pet can ride in the vehicle with a substantially reduced risk of falling or slipping out of the vehicle without providing a physical restraint that prevents the pet's movement. The vehicle pet barrier can be added to existing vehicles, can be built into new vehicles, and can be built into a floor mat for a vehicle.

### BACKGROUND

### 1. Technical Field

This invention generally relates to protecting pets in vehicles, and more specifically relates to a vehicle pet barrier that is deployed within at least a portion of an opening of the vehicle.

### 2. Background Art

Many different types of pet restraint systems for vehicles have been developed over the years. One type of pet restraint system for a vehicle uses one or more straps attached to the vehicle on one end that attach on the other end to a pet's collar to keep the pet within a desired area of the vehicle. Another type of pet restraint system for a vehicle does not attach to the pet, but instead creates a portion of the vehicle for the pet that is separate from other portions of the vehicle for the people in the vehicle. Yet another type of pet restraint system uses barriers at doors or windows that prevent the pet from exiting the vehicle.

While the known vehicle pet barriers each serve an intended purpose, each of these provide physical restraints that prevent a pet's movement in a vehicle. Experience has shown that many owners are not likely to use the physical restraints each time a pet is put into the vehicle, primarily because the restraint must then be removed each time the vehicle stops to allow the pet to exit the vehicle.

Some vehicles, such as golf carts, operate a relatively low speeds and are low to the ground. While the risk of physical injury to a pet that falls out of a golf cart is relatively low, such a fall can traumatize the pet, even when the pet is not physically injured. What is needed is a way to physically mark an edge of a doorway or other vehicle opening for a pet so the likelihood of the pet slipping or falling out of the vehicle is minimized without the owner having to take action each trip to attach a restraint to the pet and to then remove the restraint from the pet when the vehicle stops.

### BRIEF SUMMARY

A vehicle pet barrier blocks part of an opening, such as a doorway, of a vehicle without physically restraining the pet. This allows the pet to feel and sense the edge of the opening to avoid falling or slipping out as the vehicle is moving without physically restraining the pet. Once a pet becomes accustomed to the vehicle pet barrier, the pet can ride in the vehicle with a substantially reduced risk of falling or slipping out of the vehicle without providing a physical restraint that prevents the pet's movement. The vehicle pet barrier can be added to existing vehicles, can be built into new vehicles, and can be built into a floor mat for a vehicle.

The foregoing and other features and advantages of the invention will be apparent from the following more particular description of preferred embodiments of the invention, as illustrated in the accompanying drawings.

### BRIEF DESCRIPTION OF THE SEVERAL VIEWS OF THE DRAWING(S)

The preferred embodiments of the present invention will hereinafter be described in conjunction with the appended drawings, where like designations denote like elements, and:

FIG. 1 is a side view of a prior art golf cart;

FIG. 2 is a side view of an outline of part of the passenger doorway in the prior art golf cart shown in FIG. 1;

FIG. 3 is a side view of a partition member of a vehicle pet barrier according to a first embodiment;

FIG. 4 is side view of the doorway shown in FIG. 2 with attachment members for the pet barrier in FIG. 3;

FIG. 5 a cross-sectional view of a first suitable embodiment of the attachment member 410 shown in FIG. 4 taken along the line 5-5;

FIG. 6 a cross-sectional view of a first suitable embodiment of the attachment member 420 shown in FIG. 4 taken along the line 6-6;

FIG. 7 a cross-sectional view of a second suitable embodiment of the attachment member 410 shown in FIG. 4 taken along the line 5-5;

FIG. 8 a cross-sectional view of a second suitable embodiment of the attachment member 420 shown in FIG. 4 taken along the line 6-6;

FIG. 9 is a side view showing how the partition member can be installed into the doorway of the golf cart by sliding the partition member into the attachment members;

FIG. 10 is a side view of the partition member after it is installed in the attachment members;

FIG. 11 is a top view of a portion of the partition member showing how the width of the partition member can be changed to fit different vehicles;

FIG. 12 is a side view of a second embodiment of the vehicle pet barrier that deploys from within the interior of the vehicle with the partition member in a non-deployed position;

FIG. 13 is a side view of the second embodiment of the vehicle pet barrier in FIG. 12 with the partition member in a deployed position;

FIG. 14 is a top view of a first suitable implementation for the second embodiment of the vehicle pet barrier in a non-deployed position as shown in FIG. 12;

FIG. 15 is a top view of the first suitable implementation for the second embodiment of the vehicle pet barrier in a deployed position as shown in FIG. 13;

FIG. 16 is a top view of a second suitable implementation for the second embodiment of the vehicle pet barrier in a non-deployed position as shown in FIG. 12;

FIG. 17 is a top view of the second suitable implementation for the second embodiment of the vehicle pet barrier in a deployed position as shown in FIG. 13;

FIG. 18 is a perspective view of a third suitable implementation for the second embodiment of the vehicle pet barrier in a non-deployed position;

FIG. 19 is a rear view of the third implementation for the second embodiment;

FIG. 20 is a rear view of the third implementation inside a recessed chamber in the vehicle;

FIG. 21 is a rear view of the third implementation when pulled out of the recessed chamber in the vehicle to a deployed position;

FIG. 22 is a perspective view of the third implementation for the second embodiment in the deployed position;

FIG. 23 is a side view of a vehicle pet barrier according to a second implementation of the first embodiment;

FIG. 24 is a perspective view of the vehicle pet barrier in FIG. 23 deployed at the armrest of a vehicle;

FIG. 25 is a side view of a vehicle pet barrier according to a third implementation of the first embodiment;

FIG. 26 is a perspective view of a third embodiment of a vehicle pet barrier in a floor mat for a vehicle with two portions in a non-deployed position folded underneath the edge portion of the floor mat;

FIG. 27 is a top view of a portion of the floor mat in FIG. 26 with the two portions folded out and laying flat;

FIG. 28 is a perspective view of the floor mat in FIGS. 26 and 27 with the two portions deployed to block at least a portion of the doorway of the vehicle;

FIG. 29 is a perspective view of an alternative implementation for the vehicle pet barrier of the third embodiment that uses a single portion; and

FIG. 30 is a method for providing and deploying the vehicle pet barrier disclosed and claimed herein.

### DETAILED DESCRIPTION

There are many communities, especially for senior citizens and retired persons, where golf carts are the primary mode of transportation. Many people who use golf carts have pets they enjoy taking with them on the golf carts. While there are known pet restraint or pet containment systems for vehicles, virtually all of these restrain movement of the pet to assure the pet does not exit the vehicle. In many circumstances the driver of a golf cart will not take the time or effort to install a pet restraint system that prevents a pet from exiting the golf cart, primarily because of the hassle of having to take action to put a restraint in place or attach a restraint to their pet each time they get into the golf cart, and having then to remove the restraint once the golf cart stops.

The vehicle pet barrier disclosed herein provides a very simple and easy way to protect pets from accidentally falling out of a golf cart without requiring the owner take action to restrain the pet each time the owner and pet get into the golf cart, and to then take action to remove restraints each time the owner stops the golf cart and gets out. The vehicle pet barrier does not physically restrain a pet, but simply marks a boundary of the floor portion of the vehicle so the pet can remain safe inside the vehicle instead of accidentally stepping or slipping out of the doorway of the vehicle. The vehicle pet barrier preferably covers up no more than 80% of the doorway of a vehicle and preferably rises to a position lower than the bottom sitting surface of a seat in the vehicle. The vehicle pet barrier can be deployed and removed as needed. Most owners will install the vehicle pet barrier in the doorway on a passenger side of the vehicle, and will then leave the vehicle pet barrier in place so one or more pets can be taken in the vehicle without the owner taking further action at the beginning and/or end of each trip in the vehicle.

A vehicle pet barrier blocks part of an opening, such as a doorway, of a vehicle without physically restraining the pet. This allows the pet to feel and sense the edge of the opening to avoid falling or slipping out as the vehicle is moving without physically restraining the pet. Once a pet becomes accustomed to the vehicle pet barrier, the pet can ride in the vehicle with a substantially reduced risk of falling or slipping out of the vehicle without providing a physical restraint that prevents the pet's movement. The vehicle pet barrier can be added to existing vehicles, can be built into new vehicles, and can be built into a floor mat for a vehicle.

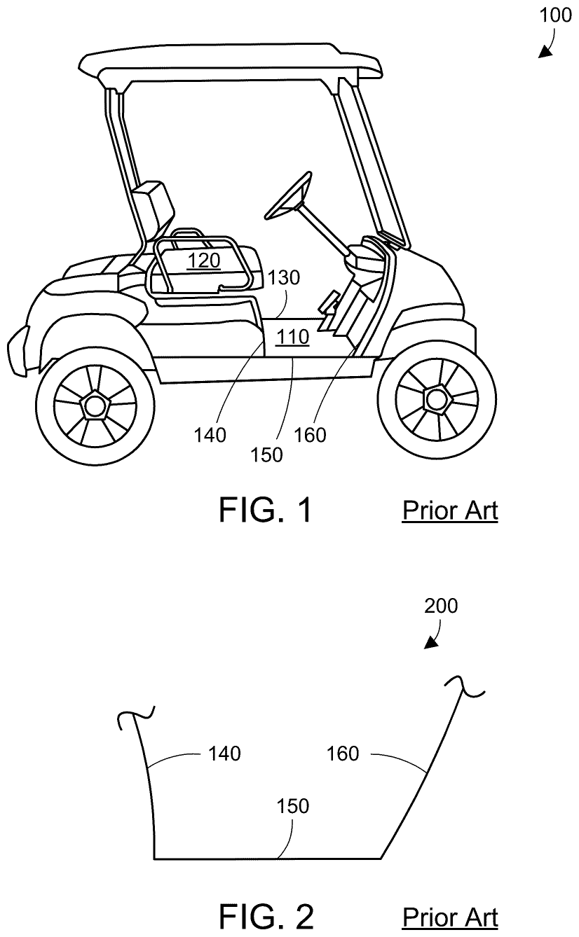

FIG. 1 shows one specific example of a golf cart 100 that is known in the art. The golf cart 100 includes a floor 110, a seat 120, a driver's side bottom edge 130 of the floor 110, a passenger's side bottom edge 150 of the of the floor 110, a back edge 140 of the passenger side doorway, and a front edge 160 of the passenger side doorway. Referring to FIG. 2, an enlarged portion of the sides and bottom of a prior art passenger side doorway 200 are shown to include the back edge 140, the bottom edge 150, and the front edge 160.

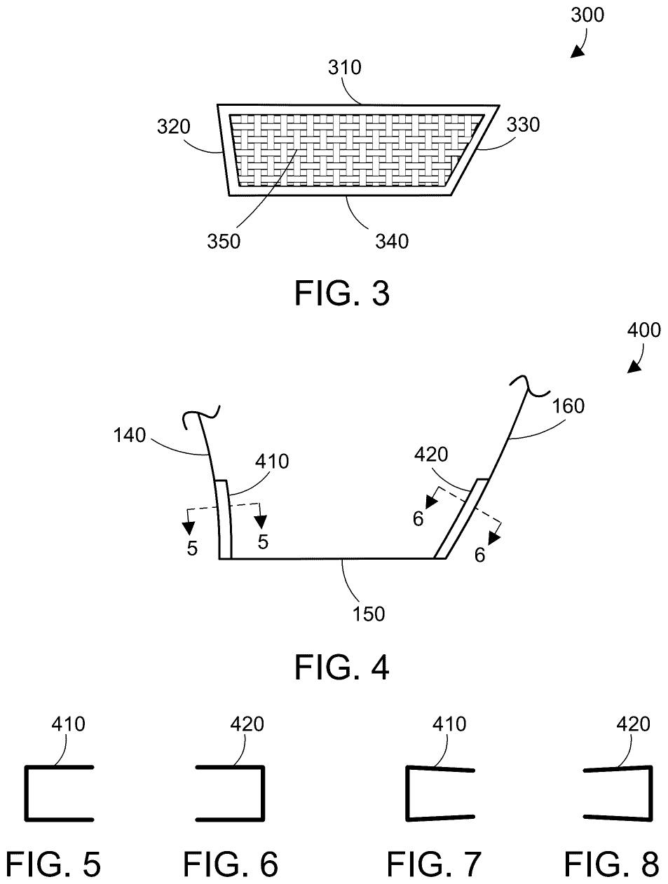

FIG. 3 shows one suitable example of a partition member 300 of the vehicle pet barrier in a first embodiment disclosed herein. The partition member 300 preferably includes a top 310, a back side 320, a front side 330, and a bottom 340, each of which could be made of a solid or tubular material, such as metal or plastic. A barrier member 350 is preferably attached to the top 310, back side 320, front side 330 and bottom 340. The barrier member 350 can be a solid rigid piece, such as a sheet of metal or plastic. In the alternative, the barrier member 350 can be a substantially flexible piece, such as a flexible plastic or fabric mesh. The barrier member 350 could also be a thin, flexible sheet of material, such as plastic or fabric. Of course, other materials could be used for the barrier member 350, all of which are within the scope of the disclosure and claims herein.

FIG. 4 shows the prior art passenger doorway shown in FIG. 2, with the back edge 140, bottom edge 150, and front edge 160, similar to what is shown in FIG. 2. Note, however, the passenger doorway 400 in FIG. 4 additionally includes a back channel member 410 and a front channel member 420 that are used to attach the partition member 300 in FIG. 3 to the vehicle. The back channel member 410 and front channel member 420 are suitable examples of attachment members that are attached to the vehicle. In the first embodiment, the combination of the partition member and at least one attachment member is what constitutes the vehicle pet barrier.

In one suitable implementation, the back channel member 410 shown in FIG. 4 could have the cross-section shown in FIG. 5, with the back of the back channel member 410 being attached to the back edge 140 of the golf cart using any suitable means, including without limitation double-stick foam tape, screws, nuts and bolts, adhesive, etc., with two arms extending towards the doorway opening to form a channel as shown in FIG. 5. The front channel member 420 shown in FIG. 4 could have a similar cross-section shown in FIG. 6, with the back of the front channel member 420 being attached to the front edge 160 of the golf cart using any suitable means, with two arms extending towards the doorway opening to form a channel as shown in FIG. 6. With the channel configuration shown in FIGS. 5 and 6, the partition member can be slid downwardly so the side portions 320 and 330 slide into respective channels members 410 and 420. In one suitable implementation, the side portions 320 and 330 have a dimension just slightly greater than the width of the channel members 410 and 420, respectively, creating an interference fit once the partition member is installed in the two channel members 410 and 420. In a different suitable implementation, the side portions 320 and 330 have a dimension just slightly smaller than the width of the channel members 410 and 420, allowing the partition member 300 to slide easily into and out of the channel members 410 and 420. In this configuration, an engagement mechanism is preferably employed between the channels members 410 and 420 and the partition member 300 to lock the partition member 300 in place in the channel members 410 and 420. For example, the channel members 410 and 420 could include holes at appropriate locations with corresponding ball detents in the sides 320 and 330 of the partition member 300 such that once the partition member 300 is slid fully into the attachment members 410 and 420, the ball detents will pop out into the holes in the channel members 410 and 420, thereby locking the partition member 300 in place in the attachment members 410 and 420. Of course, other suitable engagement mechanisms could also be used, including screws, nuts and bolts, set screws, etc. The preferred embodiments herein expressly extend to any suitable way to connect the partition member 300 to the attachment members 410 and 420.

The first side 320 and second side 330 of the partition member 300 are preferably dimensioned to fit within the channels of the channel members 410 and 420, which expressly includes dimensions smaller than the channels of the channel members and dimensions slightly larger than the channels of the channel members to provide an interference fit for the partition member 300 within the channel members 410 and 420.

In an alternative implementation, the attachment members 410 and 420 could have cross sections as shown in FIGS. 7 and 8, respectively, where the sides of the channels taper slightly towards each other. When sliding the partition member 300 into the two channels 410 and 420 shown in FIGS. 7 and 8, the tapered channels will put pressure on the partition member 300, thereby retaining the partition member 300 in place in the channels without the use of any adhesive or fasteners.

The channel members 410 and 420 shown in FIGS. 4-8, which are one example of attachment members attached to the vehicle, are preferably made of a plastic or rubber material. However, the preferred embodiments expressly extend to using any suitable material for the channel members 410 and 420 or for any other form of attachment member.

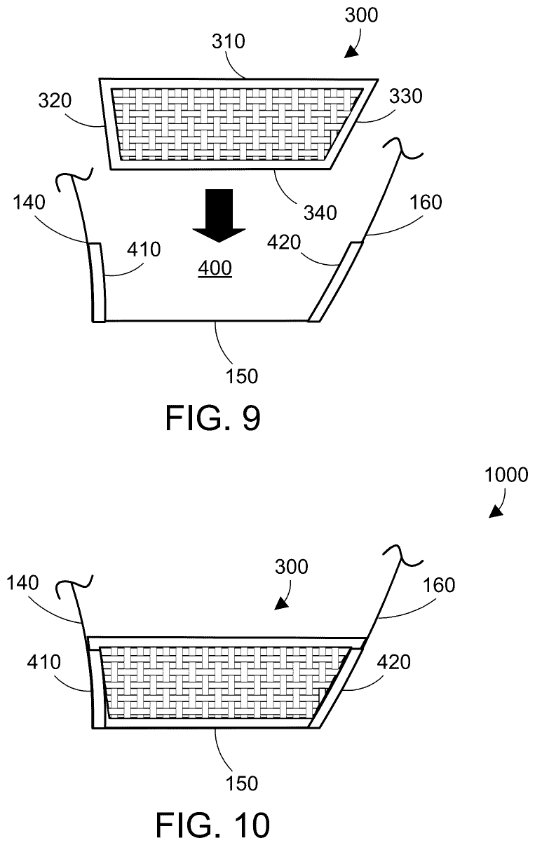

FIG. 9 shows the process of installing the partition member 300 into the channel members 410 and 420. The partition member 300 is positioned with the bottom edge 340 overlying the channel members 410 and 420, with the sides 320 and 330 being vertical. The partition member 300 is then moved down at shown by the dark arrow in FIG. 9 until the sides 320 and 330 are placed within the respective channels of channel members 410 and 420. The downward motion continues until the sides 320 and 330 of partition member 300 seat within the channel members 410 and 420. In the most preferred implementation, the sides 320 and 330 seat within the channel members 410 and 420 when the bottom 340 of the partition member 300 rests atop the bottom edge 150 of the doorway, as shown in FIG. 10. In the most preferred implementation, the partition member 300 is held in place in the attachment members 410 and 420 by a friction fit that does not require any adhesive or fasteners. Once the partition member 300 is fully installed as shown in FIG. 10, the partition member covers less than 80% of the vehicle doorway and the top 310 of the partition member 300 is lower than the bottom seat sitting surface of a seat in the vehicle, such as the sitting surface of seat 120 shown in FIG. 1.

Once the partition member 300 is installed as shown in FIG. 10, it can be easily removed, then re-deployed within the doorway as needed. For example, a driver of a golf cart may leave the partition member 300 deployed as shown in FIG. 10 most of the time. Let's assume the owner wants to use his golf cart for a round of gold with a friend. The owner could easily remove the partition member 300 by pulling up on the partition member to slide the partition member 300 out of the channel members 410 and 420, thereby allowing the owner's friend to get into an out of the golf cart without the partition member 300 in place. Once the round of golf is done, the owner could then re-deploy the partition member 300 within the doorway of the golf cart. The ease of deploying and removing the vehicle pet barrier of the first embodiment can be very advantageous.

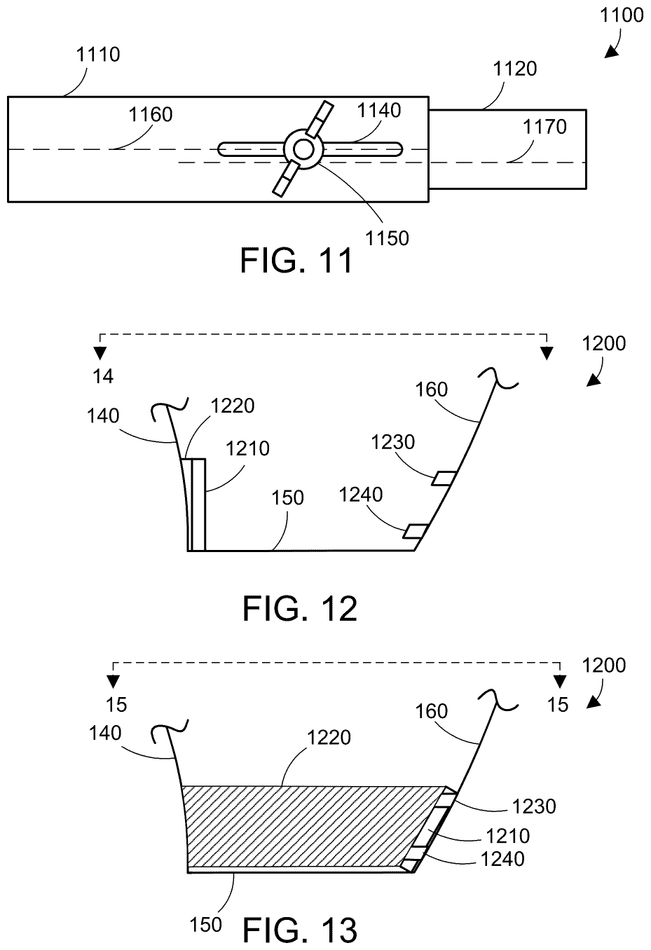

In one suitable variation, the partition member could include an adjustment mechanism that allows the partition member to be used on different sized doorways. Referring to FIG. 11, a top portion of an adjustable partition member 100 is shown to include a first portion 1110 and a second portion 1120 that slides within the first portion 1110 in a telescopic manner. The first portion 1110 includes a first barrier member 1160 in a first plane while the second portion 1120 includes a second barrier member 1170 in a different plane so the second portion 1120 can be slid in and out of the first portion 1110 while maintaining a barrier. In the specific implementation shown in FIG. 11, the first portion 1110 includes a slot 1140 and the second portion 1120 includes a threaded hole into which a wing screw 1150 with extending threaded post can be screwed until the wing screw 1150 tightens the first portion 1110 against the second portion 1120, thereby preventing the second portion 1120 from sliding with respect to the first portion 1110, which effectively fixes the width of the partition member 1100. This adjustability allows the partition member 1100 to be used with different sized doorways in different vehicles.

In a second embodiment, the partition member is built into the vehicle and can be deployed as needed. The partition member could be built into the vehicle as the vehicle is manufactured at the factory, or could be built into the vehicle as an after-market add-on. FIG. 12 shows a doorway 1200 of a vehicle that includes the back edge 140, bottom edge 150 and front edge 160, similar to what is shown in FIG. 2. Note, however, the doorway 1200 includes two attachment members 1230 and 1240 attached to the front edge 160. The partition member has a right edge 1210 and a small portion 1220 of the top visible in the doorway when the partition member is not deployed. In the configuration shown in FIG. 12, a person grabs the right edge 1210 of the partition member, which comprises a substantially cylindrical member, pulls the partition to the right, then hooks the substantially cylindrical member behind the two attachment members 1230 and 1240. In the most preferred implementation, the top of the partition member 300 in the second embodiment preferably includes at least one elastic member that allows the right side 1210 to go from the vertical position shown in FIG. 12 to the angled position shown in FIG. 13.

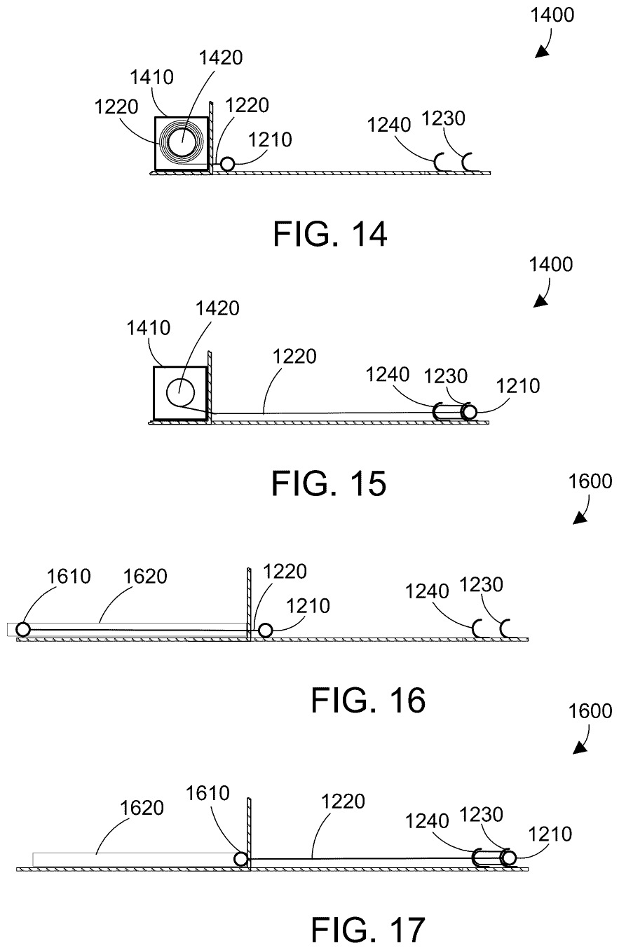

Two specific implementations of the second embodiment are shown in FIGS. 14-17. The first implementation is shown in FIGS. 14 and 15. FIG. 14 is a top view of the doorway 1200 shown in FIG. 12 along the line 14-14, while FIG. 15 is a top view of the doorway 1200 shown in FIG. 13 along the line 15-15. In the first implementation of the second embodiment shown in FIGS. 14 and 15, the partition member includes a substantially cylindrical member 1210 at its front edge, with most of the partition member being a thin, flexible material wrapped around a spring-loaded roller 1420 that provides a spring bias to keep the partition member within a canister 1410 that includes the spring roller 1420. The attachment members 1230 and 1240 shown in FIG. 12 are shown as C-shaped members in FIG. 14, making these members well-suited to receive and hold the substantially cylindrical front edge 1210. A person grabs the front edge 1210 and pulls right in FIG. 12, then hooks the substantially cylindrical front edge 1210 into the two C-shaped members 1230 and 1240, resulting in the partition member unwinding from the spring-loaded roller 1420, as shown in FIG. 15. The result is the partition is now in place as shown in FIG. 13.

In a second implementation for the second embodiment, the partition member includes a substantially rigid piece of material, such as sheet metal or plastic. With the partition member not deployed, as shown in FIGS. 12 and 16, only the front edge 1210 and a small portion of the top 1220 are visible, while the rest of partition member 300 is within an interior portion of the vehicle that is not visible from the exterior of the vehicle. The interior portion of the vehicle includes a track 1620 in which the partition member slides when pulled on to deploy and when pushed back in. When in the position shown in FIGS. 12 and 16, a person grabs the front edge 1210 and pulls right, causing the partition member to slide within the track 1620 until the person hooks the substantially cylindrical front edge 1210 into the two C-shaped members 1230 and 1240, as shown in FIGS. 13 and 17. While most of the partition member is substantially rigid, in this second implementation of the second embodiment the partition member also includes a substantially elastic portion, such as near the front edge 1210, that allow the front edge to move from a vertical position shown in FIG. 12 to an angled position shown in FIGS. 13 and 17.

While the first and second embodiments shown in FIGS. 3-17 show the partition member 300 extending to the bottom of the doorway, it is equally within the scope of the preferred embodiments to provide a gap between the bottom of the doorway and the bottom of the partition member 300.

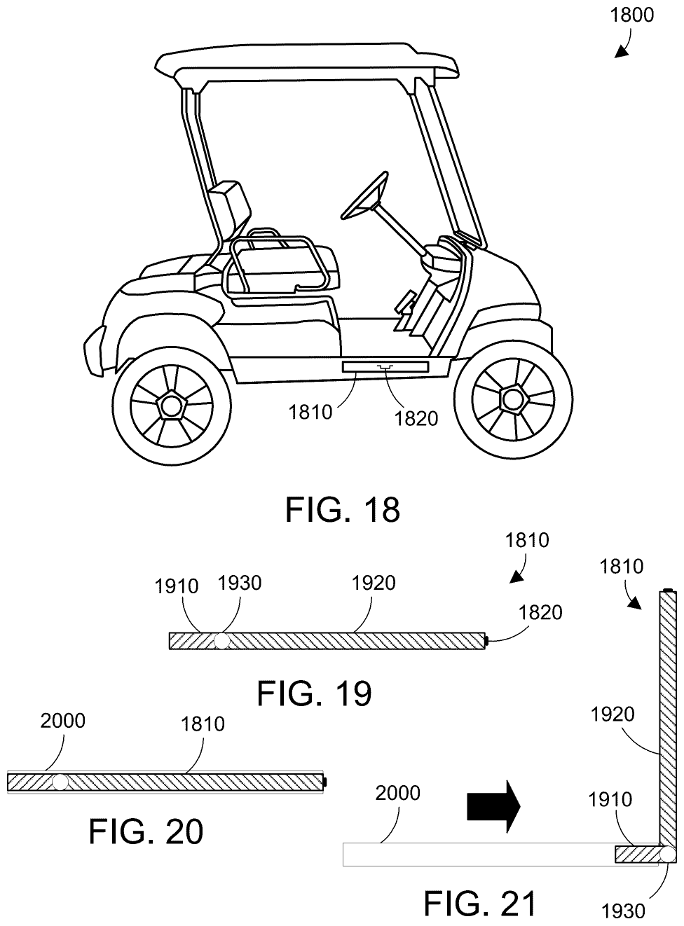

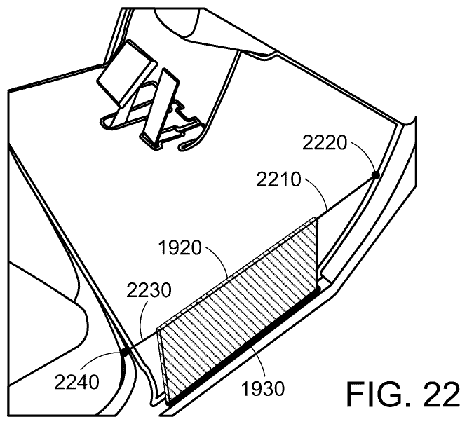

A third implementation of the second embodiment has the vehicle pet barrier within a recessed compartment of the vehicle, which can be deployed by pulling the pet barrier out like a drawer and pivoting the pet barrier up to a deployed position. Referring to FIGS. 18-22, a vehicle pet barrier 1810 is shown in FIG. 18 in a non-deployed position. Vehicle pet barrier 1810 preferably includes a handle 1820 that allows a person to grab the handle and pull the vehicle pet barrier 1810 out to a deployed position. The pet barrier 1810 includes a first portion 1910 and a second portion 1920 coupled together via a suitable pivoting mechanism 1930. The pivoting mechanism 1930 can be any suitable mechanism that allows the second portion 1920 to pivot with respect to the first portion 1910, including without limitation one or more hinge-type members, a thinned portion of flexible material, etc. When in the non-deployed position as shown in FIG. 18, the pet barrier 1810 resides within a recessed chamber 2000 in the vehicle, as shown in FIG. 20. A person deploys the pet barrier 1810 by grasping the handle 1820 and pulling the pet barrier 1810 out of the recessed chamber 2000 like a drawer until the second portion 1920 is entirely out of the recessed chamber 2000, which allows the person to then pivot the second portion 1920 upwards as shown in FIG. 21 until it covers at least a portion of the doorway of the vehicle, as shown in FIG. 22. In the most preferred implementation, there is a retaining member that keeps the pet barrier 1810 within the recessed chamber 2000 as shown in FIG. 20 so the pet barrier 1810 does not slide out of the recessed chamber 2000 inadvertently. In addition, the recessed chamber 2000 preferably includes one or more stop members that limit the travel of the first portion 1910 of the pet barrier 1810 as shown in FIG. 21 so the first portion 1910 does not slide out of the recessed chamber 2000. The second portion 1920 of pet barrier 1810 can include straps or elastic members 2210 and 2230 that are attached to the second portion 1920 and can then be attached to respective attachment members 2220 and 2240 on the vehicle to retain the second portion 1920 in the deployed position, as shown in FIG. 22.

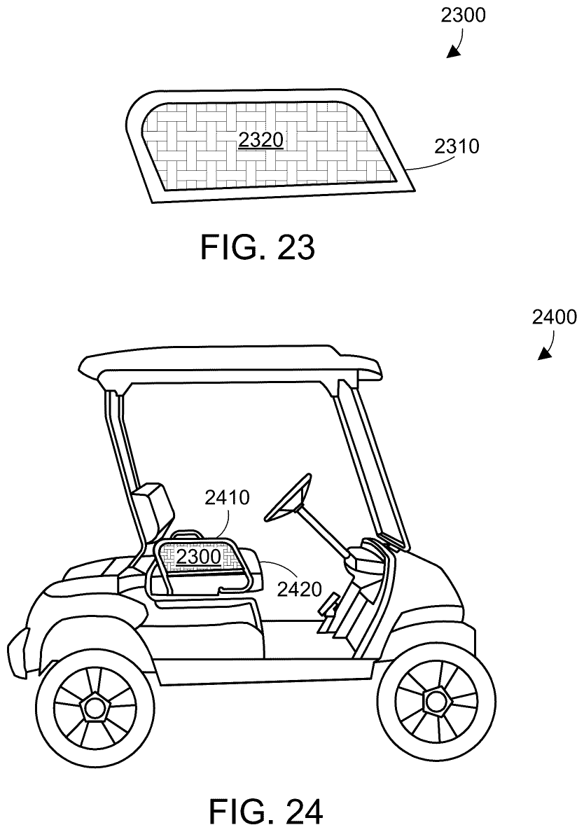

A second implementation of the first embodiment of the vehicle pet barrier is shown in FIGS. 23 and 24. The pet barrier 2300 includes a frame portion 2310 and a barrier member 2320. The pet barrier 2300 is shaped to block at least a portion of an open armrest 2410 that lies above a seat 2420 in a vehicle, shown in FIG. 24. The pet barrier 2300 may be attached to the armrest 2410 or to one or more other attachment members in the vehicle using any suitable fastener or attachment means.

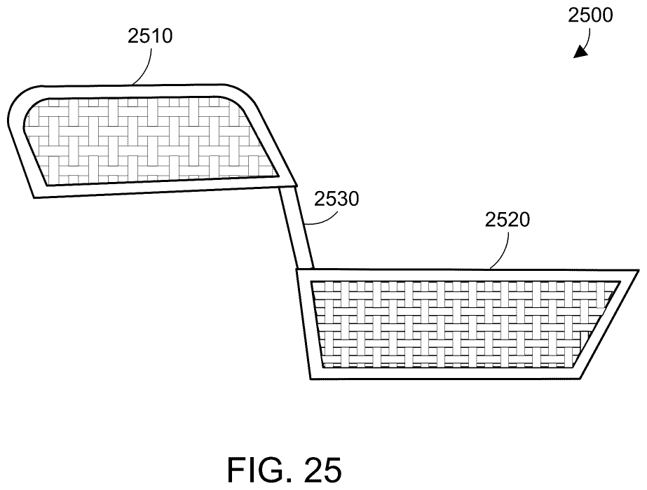

A third implementation of the first embodiment of the vehicle pet barrier is shown in FIG. 25. The pet barrier 2500 includes a first portion 2510 and a second portion 2520 with a connector member 2530 that interconnects the two. The first portion 2510 is configured to cover at least a portion of the armrest opening by a seat, similar to pet barrier 2300 in FIGS. 23 and 24. The second portion 2520 is configured to cover at least a portion of the doorway of the vehicle, similar to partition member 300 shown in FIGS. 3, 9 and 10. The connecting member 2530 can be a rigid or flexible member, and may allow the two portions 2510 and 2520 to pivot with respect to each other. The pet barrier 2500 thus allows blocking a portion of two different openings of the vehicle.

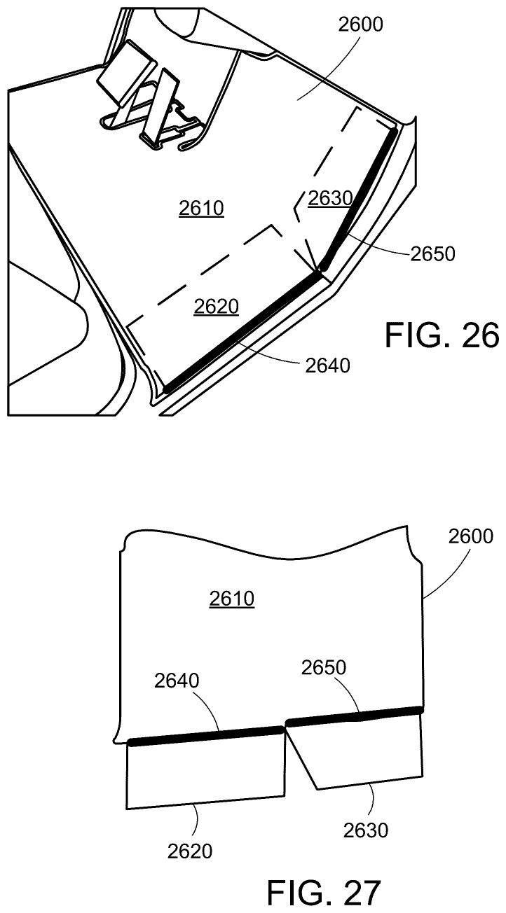

A third embodiment provides a vehicle pet barrier in a floor mat for a vehicle. FIG. 26 shows a floor mat 2600 that includes a first portion 2610 that is configured to fit within the vehicle. First portion 2610 is similar in size and shape to a known mat for a golf cart, and substantially covers the floor of the golf cart. Floor mat 2600 includes folded portions 2620 and 2630 that are folded underneath the first portion 2610 when in a non-deployed position, as shown by the dotted lines in FIG. 26. The folded portions 2620 and 2630 are pivotally coupled to the first portion 2610 via pivot points 2640 and 2650, respectively. The pivot points 2640 and 2650 could be any known way to allow the folded portion 2620 and 2630 to pivot with respect to the first portion 2600, such as a hinge-type mechanism, a thinner plastic or rubber portion, etc. The disclosure and claims herein extend to any suitable way to make portions of the floor mat pivot with respect to other portions of the floor mat, whether currently known or developed in the future.

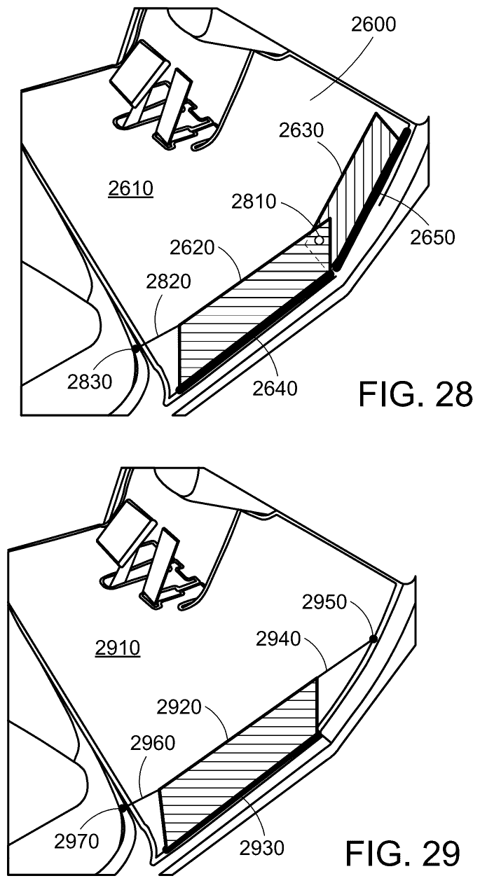

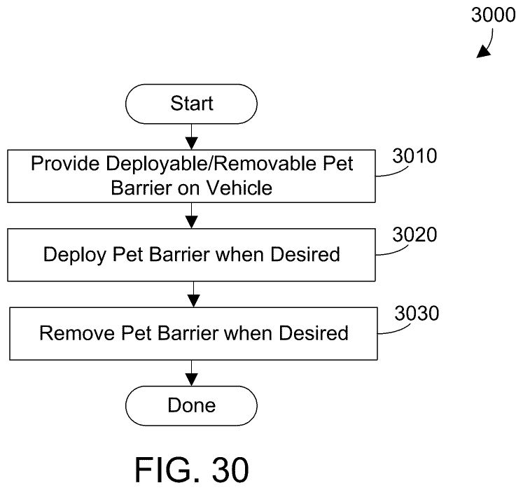

FIG. 27 shows the portion of the floor mat 2600 that is at the passenger side door of the vehicle when laid flat, which includes the first portion 2610, the first folded portion 2620 connected via pivot point 2640 to the first portion 2610, and the second folded portion 2630 connected via pivot point 2650 to the first portion 2610. We assume the floor mat 2600 is installed in the vehicle with the first and second folded portions 2620 and 2630 folder under as shown by the dotted lines in FIG. 26, which is the non-deployed positions for folded portions 2620 and 2630. Deploying the vehicle pet barrier is done by lifting the passenger-side edge of mat 2610 and unfolding the first folded portion 2620 and the second folded portion 2630, then bringing them to a near vertical position with respect to the floor of the vehicle, as shown in FIG. 28. Note the first and second folded portions 2620 and 2630, respectively, have a wedge-shaped notch between them when the mat 2600 is laid flat, as shown in FIG. 27. Because the floor mat covers not only the flat bottom of the floor but the angled front of the floor as well, the angle between the floor and the front causes the first and second folded portions 2620 and 2630 to overlap, as shown in FIG. 28. In the most preferred implementation of the third embodiment, the first and second folded portions 2620 and 2630 include a fastener 2810 that connects the two together once they are raised to the deployed position, as shown in FIG. 28. The fastener could be a snap, zip tie, or any other suitable fastener. In addition, either the first folded portion 2620, the second folded portion 2630, or both, could include an elastic member that attaches to one or more attachment members on the vehicle. For the specific example in FIG. 28, the first folded portion 2620 includes an elastic portion 2820 that connects to a suitable attachment member 2830 on the vehicle to help maintain the second folded portion 2620 within the doorway of the vehicle. Attachment member 2830 could take any suitable form. For example, attachment member 2830 could be a circular member with an annular groove, and the elastic portion 2820 could include an eyelet that is slipped over the circular member into the annular groove. In another example, attachment member 2830 could be a member that provides a hole, with elastic portion 2820 including a hook that engages the hole of the attachment member 2830. The disclosure and claims herein extend to any suitable attachment member that can be used to attach at least a portion of the vehicle pet barrier to at least a portion of the vehicle.

One suitable example of a second implementation for the third embodiment is shown in FIG. 29 and includes a single folded portion 2920 coupled to the first mat portion 2910 via a pivoting member 2930. The folded portion 2920 includes a first elastic member 2940 on the front end that attaches to an attachment member 2950 that is attached to the vehicle, and further includes a second elastic member 2960 on the back end that attaches to an attachment member 2970 that is attached to the vehicle. The third embodiment of the invention expressly extends to any suitable number of folded portions in a floor mat and any suitable number of elastic portions that attach to any suitable attachment members or mechanisms on the vehicle to at least partially retain one or more folded portions in the doorway of the vehicle when the folded portions are in the deployed position.

A method 3000 for using the vehicle pet barrier provides a deployable/removable pet barrier on a vehicle (step 3010). The pet barrier can be deployed when desired (step 3020) and can be removed when desired (step 3030). Method 3000 is then done. The vehicle pet barrier disclosed and claimed herein provides a barrier that better protects pets from falling or slipping out of a vehicle without requiring the pet's owner to take actions each time the pet is put into the vehicle or taken out of the vehicle.

A vehicle pet barrier blocks part of an opening, such as a doorway, of a vehicle without physically restraining the pet. This allows the pet to feel and sense the edge of the opening to avoid falling or slipping out as the vehicle is moving without physically restraining the pet. Once a pet becomes accustomed to the vehicle pet barrier, the pet can ride in the vehicle with a substantially reduced risk of falling or slipping out of the vehicle without providing a physical restraint that prevents the pet's movement. The vehicle pet barrier can be added to existing vehicles, can be built into new vehicles, and can be built into a floor mat for a vehicle.

The disclosure and claims herein support a vehicle pet barrier comprising: at least one attachment member attached to a vehicle; a partition member comprising a top, first and second sides coupled to the top, and a bottom coupled to the first and second sides; and wherein the partition member is removably attached to the at least one attachment member so the partition member is deployed within at least a portion of an opening of the vehicle.

The disclosure and claims herein further support a vehicle pet barrier comprising: a floor mat for a vehicle comprising: a first portion that overlies at least a portion of the floor of the vehicle; and a second portion that is pivotally connected to the first portion so the second portion underlies the first portion when the second portion is in a non-deployed position and so the second portion can pivot from underlying the first portion to being in a deployed position to at least partially block a portion of a doorway of the vehicle.

The disclosure and claims herein additionally support a vehicle pet barrier comprising: a first attachment member having a first back portion attached to a first side of a doorway of a vehicle and having first and second side portions extending from the first back portion into the doorway of the vehicle to form a first channel; a second attachment member having a second back portion attached to a second side of the doorway of the vehicle opposite the first side of the doorway of the vehicle and having first and second side portions extending from the second back portion into the doorway of the vehicle to form a second channel; a partition member comprising: a top; a first side coupled to the top, wherein the first side is dimensioned to fit within the first channel of the first attachment member; a second side coupled to the top, wherein the second side is dimensioned to fit within the second channel of the second attachment member; a bottom coupled to the first and second sides; and a substantially flexible barrier member attached to the top, the first side, the second side, and the bottom; wherein the partition member is slid into the first channel of the first attachment member and into the second channel of the second attachment member while sliding the partition member downward until the partition member seats within the first and second attachment members, thereby deploying the vehicle pet barrier within the doorway of the vehicle.

While the invention has been particularly shown and described with reference to preferred embodiments thereof, it will be understood by those skilled in the art that various changes in form and details may be made therein without departing from the spirit and scope of the invention. For example, while all of the examples herein show the vehicle pet barrier on the passenger side doorway, the vehicle pet barrier could be deployed on the driver side doorway as well.

1. A vehicle pet barrier comprising:
at least one attachment member attached to a vehicle;
a partition member removably attached to the at least one attachment member so the partition member is deployed within at least a portion of an opening of the vehicle.

2. The vehicle pet barrier of claim 1 wherein the opening of the vehicle comprises a doorway of the vehicle, wherein the at least one attachment member comprises two channel members attached to two opposing sides of the doorway of the vehicle.

3. The vehicle pet barrier of claim 1 wherein the partition member comprises a top, first and second sides coupled to the top, a bottom coupled to the first and second sides, and a substantially flexible barrier member between the top, first and second sides, and bottom.

4. The vehicle pet barrier of claim 1 wherein the partition member comprises a top, first and second sides coupled to the top, a bottom coupled to the first and second sides, and a mesh barrier portion between the top, first and second sides, and bottom.

5. The vehicle pet barrier of claim 1 wherein at least a portion of the partition member is substantially elastic.

6. The vehicle pet barrier of claim 1 wherein the at least one attachment member comprises at least one C-shaped member attached to the vehicle that receives a substantially cylindrical member on a side of the partition member to hold the partition member in place within a doorway of the vehicle.

7. The vehicle pet barrier of claim 1 wherein the partition member comprises a top, first and second sides coupled to the top, and a bottom coupled to the first and second sides, wherein the partition member is substantially flexible, wherein the first side and most of the top and bottom of the partition member are rolled up on a spring-loaded roller when the partition member is not deployed.

8. The vehicle pet barrier of claim 7 wherein the second side and most of the top and bottom of the partition member are not rolled up on the spring-loaded roller when the partition member is deployed.

9. The vehicle pet barrier of claim 1 wherein the partition member comprises a top, first and second sides coupled to the top, and a bottom coupled to the first and second sides, wherein the partition member is substantially rigid, wherein the first side and most of the top and bottom of the partition member are not visible and are within an interior portion of the vehicle when the partition member is not deployed.

10. The vehicle pet barrier of claim 9 wherein the partition member can be slid from a non-deployed position to a deployed position within the at least a portion of the opening of the vehicle, wherein the second side and most of the top and bottom of the partition member are within the at least a portion of an opening of the vehicle when the partition member is deployed.

11. The vehicle pet barrier of claim 1 wherein when the partition member is deployed within the at least one opening of the vehicle the top of the partition member is below a bottom seat sitting surface of a seat in the vehicle.

12. The vehicle pet barrier of claim 1 wherein when the partition member is deployed within the at least one opening of the vehicle the partition member blocks less than 80% of the at least one opening of the vehicle.

13. The vehicle pet barrier of claim 1 wherein the top, first and second sides and bottom of the partition member are substantially rigid, wherein the partition member further comprises a substantially flexible barrier member attached to and extending between the top, first and second sides, and bottom.

14. The vehicle pet barrier of claim 13 wherein the substantially flexible barrier member comprises a fabric mesh.

15. The vehicle pet barrier of claim 1 further comprising at least one adjustment mechanism that allows varying a width of the partition member to fit in different sized openings of vehicles.

16. A vehicle pet barrier comprising:
a floor mat for a vehicle comprising:
a first portion that overlies at least a portion of the floor of the vehicle; and
a second portion that is pivotally connected to the first portion so the second portion underlies the first portion when the second portion is in a non-deployed position and so the second portion can pivot from underlying the first portion to being in a deployed position to at least partially block a portion of a doorway of the vehicle.

17. The vehicle pet barrier of claim 16 wherein the floor mat further comprises a third portion that is separate from the second portion, wherein the third portion is pivotally connected to the first portion so the third portion underlies the first portion when the third portion is in a non-deployed position and so the third portion can pivot from underlying the first portion to being in a deployed position to at least partially block a portion of the doorway of the vehicle, wherein the third portion comprises at least one fastener for attaching the second portion to the third portion when the second portion and the third portion are in the deployed position.

18. The vehicle pet barrier of claim 16 further comprising at least one attachment member attached to the vehicle, wherein the second portion is attached to the at least one attachment member when the second portion is in the deployed position to retain the second portion within the doorway of the vehicle.

19. The vehicle pet barrier of claim 18 wherein the third portion is attached to the at least one attachment member when the third portion is in the deployed position to retain the third portion within the doorway of the vehicle.

20. A vehicle pet barrier comprising:
a first attachment member having a first back portion attached to a first side of a doorway of a vehicle and having first and second side portions extending from the first back portion into the doorway of the vehicle to form a first channel;
a second attachment member having a second back portion attached to a second side of the doorway of the vehicle opposite the first side of the doorway of the vehicle and having first and second side portions extending from the second back portion into the doorway of the vehicle to form a second channel;
a partition member comprising:
a top;
a first side coupled to the top, wherein the first side is dimensioned to fit within the first channel of the first attachment member;
a second side coupled to the top, wherein the second side is dimensioned to fit within the second channel of the second attachment member;
a bottom coupled to the first and second sides; and
a substantially flexible barrier member attached to the top, the first side, the second side, and the bottom;
wherein the partition member is slid into the first channel of the first attachment member and into the second channel of the second attachment member while sliding the partition member downward until the partition member seats within the first and second attachment members, thereby deploying the vehicle pet barrier within the doorway of the vehicle.
